(19) United States
(12) Patent Application Publication
(10) Pub. No.: US 2004/0184015 A1
(43) Pub. Date: Sep. 23, 2004

(54) Aligner and device fabrication method

(76) Inventor: Yoshiki Kino, Tochigi (JP)

Correspondence Address: MORGAN & FINNEGAN, L.L.P., 345 PARK AVENUE, NEW YORK, NY, 10154, US

(21) Appl. No.: 10/802,413

(22) Filed: Mar. 16, 2004

(30) Foreign Application Priority Data
Mar. 18, 2003 (JP) 2003-073178

(51) Int. Cl. G03B 27/52

(52) U.S. Cl. 355/30; 355/53; 355/69; 356/399; 356/400; 356/401

(57) ABSTRACT

To provide an aligner capable of controlling a proper light exposure in accordance with an oxygen density and moisture density on an laser beam optical path, an aligner of the present invention is an aligner for illuminating a mask (or reticle) with the light emitted from a light source to expose an object to be exposed with the light reflected from the mask, which is provided with the following:

oxygen density detection means for detecting an oxygen density on an optical path from the light source up to the object to be exposed;

moisture density detection means for detecting a moisture density on the optical path; and

control means for controlling a light exposure irradiated to the object to be exposed based on the detection results of the oxygen density detection means and the moisture density detection means.

### BACKGROUND OF THE INVENTION

1. Field of the Invention

The present invention relates to an aligner used to fabricate a semiconductor device, liquid-crystal display device or thin-film magnetic head.

2. Related Background Art

It is requested for an aligner such as a semiconductor aligner to expose a photoconductor such as a wafer at a target light exposure. It is difficult to control a light exposure on the photoconductor by directly measuring the light exposure. Therefore, a conventional aligner takes out some of illumination light emitted from a light source by a half mirror and measures it by a quantity-of-light detector to control a light exposure so that a photoconductor is exposed at a target light exposure in accordance with the measured value of the quantity-of-light detector. A relation between a value of the quantity-of-light detector and an actual quantity of light of the photoconductor is previously calibrated.

A recent aligner has to use an ArF excimer laser beam having a shorter wavelength as a light source in accordance with a request for miniaturizing a semiconductor. However, because some of the ArF excimer laser beam is absorbed in oxygen molecules and consumed as the energy for ozonization, a light exposure is decreased. Therefore, it is necessary to consider an oxygen density on an optical path. Moreover, because the oxygen density on the optical path is fluctuated (decreased) due to ozonization, an exposure energy quantity to be absorbed in oxygen molecules is not constant. To solve this problem, a method is already proposed which realizes high-accuracy light exposure control by using means for measuring an oxygen density on the optical path of illumination light and correcting a light exposure in accordance with the measured value (Japanese Patent Application Laid-Open No. H11-87230).

However, because of a request for further miniaturizing an aligner, it is demanded to use the F₂ excimer laser beam having a wavelength shorter than that of an ArF excimer laser beam. When using the F₂ excimer laser beam as a light source, some of the excimer laser beam is absorbed in not only oxygen but also moisture on an optical path. Therefore, when using the F₂ excimer laser beam as a light source, it is necessary to control not only an oxygen density but also a moisture density. Therefore, a light exposure is not proper unless a moisture density is proper even if an oxygen density is proper.

It is an illustrative object of the present invention to solve problems of the prior art and provide an aligner capable of performing a proper light exposure control in accordance with an oxygen density and moisture density on an laser beam optical path.

### SUMMARY OF THE INVENTION

According to the present invention, there is provided an aligner for illuminating a mask (or reticle) with light emitted from a light source and exposing an object to be exposed with light reflected from the mask, comprising:

oxygen density detection means for detecting an oxygen density on an optical path between the light source and the object to be exposed;

moisture density detection means for detecting a moisture density on the optical path; and

control means for controlling a light exposure to be irradiated to the object to be exposed based on the detection results of the oxygen density detection means and the moisture density detection means.

In the aligner according to present invention, quantity-of-light detection means is included which detects a quantity of light at a predetermined position on the optical path.

In the aligner according to present invention, light exposure detection means is included which detects a quantity of light irradiated to the object to be exposed.

In the aligner according to present invention, the control means controls the light exposure in accordance with a relation between an absorbed quantity of light emitted from the light source (absorptance of light having a wavelength emitted from the light source) and an oxygen density (relation between absorbed quantity of light irradiated to the object to be exposed and a certain oxygen density).

In the aligner according to present invention, a relation between an oxygen density and an absorptance of light emitted from the light source is previously included as data.

In the aligner according to present invention, the control means controls the light exposure in accordance with a relation between an absorbed quantity of light emitted from the light source (absorptance of light having a wavelength emitted from the light source) and a moisture density (relation between an absorbed quantity of light irradiated to the object to be exposed and a certain moisture density).

In the aligner according to present invention, a relation between a moisture density and an absorbed quantity of light emitted from the light source is previously included as data.

In the aligner according to present invention, the light emitted from the light source is an excimer laser beam.

In the aligner according to present invention, the excimer laser beam is an F₂ laser beam.

In the aligner according to present invention, the control means has an ND filter and the ND filter controls a light exposure to be irradiated to the object to be exposed.

In the aligner according to present invention, the control means has a diaphragm to control a light exposure to be irradiated to the object to be exposed by changing opening diameters of the diaphragm.

According to the present invention, there is provided a device fabrication method comprising:

a step of exposing the object to be exposed by using the aligner of present invention; and

a step of developing the exposed object.

According to the present invention, there is provided an aligner for transferring a pattern formed on a mask or reticle to an object to be exposed comprising:

quantity-of-light detection means for detecting a quantity of exposure light;

oxygen density detection means for detecting an oxygen density in an exposure environment;

moisture density detection means for detecting a moisture density in the exposure environment; and

control means for controlling the quantity of the exposure light in accordance with data showing the relation between the oxygen density, the moisture density and the absorbed quantity of the exposure light and detection results by the oxygen density detection means and the moisture detection means previously obtained.

According to the present invention, there is provided a device fabrication method comprising:

a step exposing the object to be exposed by using the aligner of present invention; and

a step of developing the exposed object.

Increasing objects and other characteristics of the present invention will become more apparent by preferred embodiments to be described by referring to the following drawings.

### BRIEF DESCRIPTION OF THE DRAWINGS

FIG. 1 is a schematic block diagram of an essential portion of an aligner of an embodiment of the present invention;

FIG. 2 is a flowchart for calculating a correction value used for light exposure control of the present invention;

FIG. 3 is a schematic block diagram of the aligner further comprising quantity-of-light change means shown in FIG. 1;

FIG. 4 is a flowchart for explaining the light-exposure control operation by the quantity-of-light change means shown in FIG. 3;

FIG. 5 is a flowchart for explaining a method for fabricating a device having an aligner of the present invention; and

FIG. 6 is a detailed flowchart of the step 4 shown in FIG. 5.

### DESCRIPTION OF THE PREFERRED EMBODIMENTS

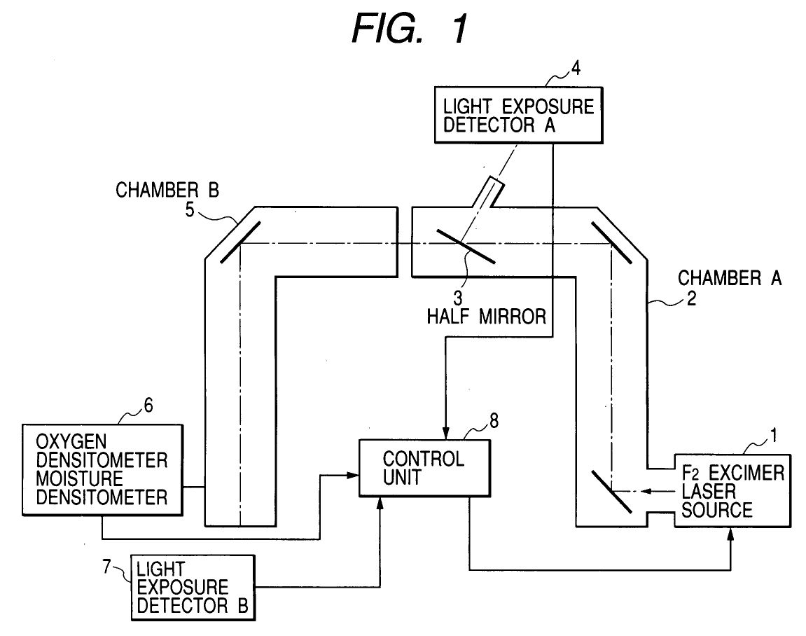

An aligner of an embodiment of the present invention is described below by referring to FIG. 1. In this case, FIG. 1 is a schematic block diagram of an essential portion of an aligner relating to this embodiment. In FIG. 1, reference numeral 1 denotes an F₂ excimer laser beam source. Reference numeral 2 denotes a chamber A holding a not-illustrated illumination optical system in which the chamber A is hermetically closed so that ambient air does enter the chamber A and nitrogen is injected from the outside. The chamber A includes an optical system (such as mirror for folding optical path) for leading an excimer laser beam emitted from the excimer laser beam source 1 to a chamber B to be described later and an optical integrator.

Reference numeral 3 denotes a half mirror which divides a quantity of light transmitted through an illumination optical system. Reference numeral 4 denotes a light exposure detector A for detecting quantities of light divided the half mirror 3, which indirectly measures a light exposure difficult to directly measure during exposure on the surface of a not-illustrated wafer. Reference numeral 5 denotes a chamber B in which the remaining components of the lighting optics and a light-projection optical system for projecting an integrated circuit pattern formed on a not-illustrated mask or reticle is set. The chamber B is also hermetically closed so that ambient air does not enter the chamber B similarly to the case of the chamber A and nitrogen is injected from the outside so that an oxygen density and moisture density can be decreased.

In the case of this embodiment, the chamber A is separated from the chamber B. However, it is also allowed to constitute the both chambers A and B as an integrated chamber. Moreover, it is allowed to separately constitute an illuminating chamber for receiving light from a light source and leading it up to a wafer and a projecting chamber for receiving light from a reticle and leading it up to a wafer. Furthermore, it is allowed to constitute the illuminating chamber by a plurality of chambers, the projecting chamber by a plurality of chambers or the both chambers by a plurality of chambers.

Reference numeral 6 denotes an oxygen-moisture densitometer for detecting an oxygen density and moisture density in a chamber B5. It is recommended to set detection sections of the oxygen-moisture densitometer 6 on an optical path because it is preferable to directly detect an oxygen density and moisture density on the optical path. However, when the optical path is interrupted by a detection section on the optical path, it is also allowed to set the detection section nearby the optical path. Moreover, a measuring position is not restricted when it is possible to calculate an oxygen density and moisture density on the optical path in accordance with measured values of the oxygen moisture densities by previously measuring the oxygen and moisture densities on the optical path and at a position which is not nearby the optical path and examining the relation between measured values at the position and measured values of the oxygen and moisture densities on the optical path (through a simulation or the like). It is more preferable to use a plurality of measuring positions than one measuring position and it is preferable to measure oxygen and moisture densities at each position and calculate the transmittance of light at each position and then control a light exposure in accordance with the calculated result. It is also allowed to average measured results at a plurality of positions.

It is principally allowed to set the oxygen-moisture densitometer 6 at any position. When oxygen and moisture densities at a certain position can be obtained, it is possible to calculate a transmittance by the following expression in accordance with an absorptance by oxygen and moisture and an optical path length (excluding a lens thickness) up to the position.

Transmittance=EXP\hat{ }(−(absorptance)×(density)×(optical path excluding lens thickness) (Numerical formula 1)

Therefore, because the transmittance is calculated at the position when a plurality of measuring positions is used, it is possible to more accurately obtain a relation between measured value and calculated value.

Reference numeral 7 denotes a light exposure detector B for detecting a light exposure immediately after passing through a not-illustrated projecting optical system, which is set on the surface of a not-illustrated wafer. The light exposure detector B7 is not used at the time of exposure but a light exposure detector A4 is used.

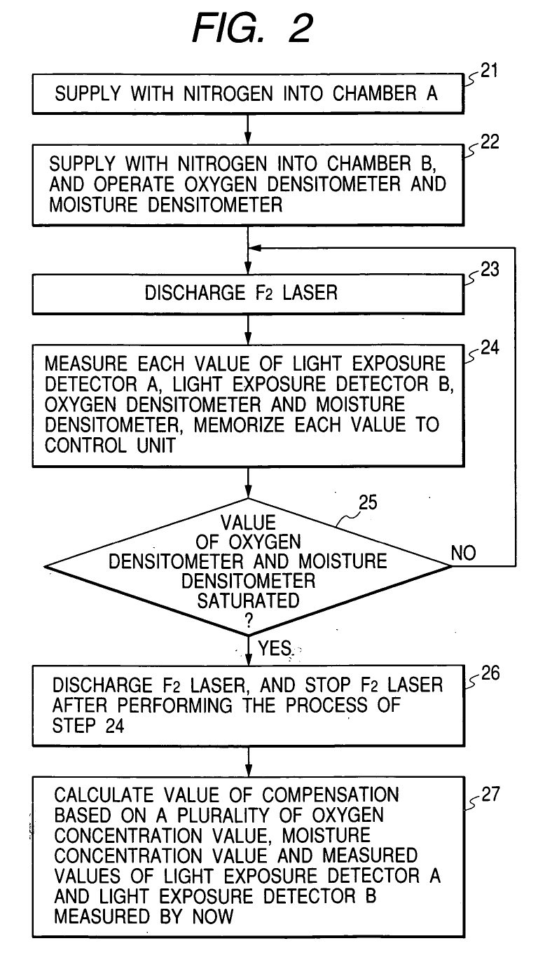

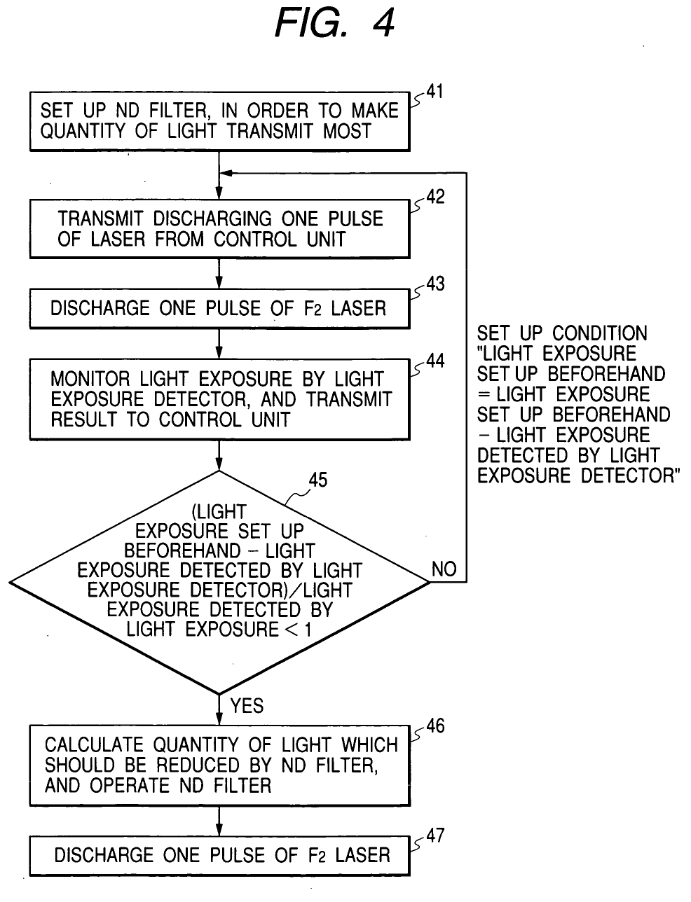

Reference numeral 8 denotes a controller for storing and computing results obtained from the light exposure detectors A and B and the oxygen-moisture densitometer 6 and controlling the light emitted from the F₂ excimer laser beam source 1. The controller 8 includes a not-illustrated control section and a memory connected to the control section. The memory stores data showing a relation between oxygen density, moisture density and absorbed quantity of exposure light and a flowchart of the light exposure control operation of this embodiment to be described later by referring to FIGS. 2 and 4 as programs. The memory has a concept of including a volatile memory and a nonvolatile memory.

It is allowed to show data by a graph in which oxygen density or moisture density is assigned to the axis of abscissa and absorbed quantity of exposure light (%) is assigned to the axis of ordinate. Moreover, it is allowed to three-dimensionally show oxygen density, moisture density and quantity of exposure light absorbed in oxygen and moisture by a graph in which the oxygen density is assigned to X axis, moisture density is assigned to Y axis and quantity of exposure light absorbed in oxygen and moisture is assigned to Z axis. Furthermore, it is allowed to store a database showing a relation between oxygen density, moisture density and absorbed quantity of exposure light in the memory instead of a graph.

In the case of this embodiment, the relation between the light exposure detectors A and B is obtained from values of the oxygen density and moisture density in the chamber B5.

First, it is possible to calculate the quantity of a laser beam absorbed in an optical system in the chamber B in accordance with the configuration of the optical system. The optical system includes not only a lens but also a mirror. In the case of the lens, the transmittance of the lens is shown by the following expression.

Transmittance=glass transmittance (1/cm) \hat{ } glass thickness (cm) (Numerical formula 2)

Therefore, the quantity of light when passing through a lens is shown by the following expression.

Quantity of light after transmission=Quantity of light before transmission×Transmittance (Numerical formula 3)

In the case of a mirror, the following expression is applied.

Quantity of light after reflection=Reflectance of mirror×Quantity of light before reflection (Numerical formula 4)

It is possible to similarly calculate the quantity of a laser beam absorbed in oxygen and moisture. It is possible to use the above three-dimensional graph for an absorbed quantity. For example, by using the graph, it is possible to calculate an absorptance of exposure light by oxygen molecules when an oxygen density is 3 ppm is 4.46%/m. Therefore, it is possible to calculate the light exposure on the surface of a not-illustrated wafer in accordance with the following expression.

E_{B}=E_{A}−C_{B}−O_{B}−W_{B} (Numerical formula 5)

In the above expression, E_{B} denotes a value measured by the light exposure detector B7, E_{A} denotes a value measured by the light exposure detector A4, C_{B} denotes a quantity of (transmission member and reflection member of) a laser beam absorbed in an optical system in the chamber B5, O_{B} denotes a quantity of a laser beam absorbed in oxygen molecules in the chamber B5 and W_{B} denotes a quantity of a laser beam absorbed in moisture in the chamber B5.

In fact, however, transmittance cannot be obtained from Numerical formula 1 but it can be obtained from the following Numerical formula 6.

E_{B}=E_{A}−C_{B}−O_{B}−W_{B}−F_{B} (Numerical formula 6)

In the above expression, F_{B} denotes a correction value. The correction value F_{B} results from an unexpected error in an optical system, which is a correction value for correcting Numerical formula 1 and must be obtained before exposure. A method for calculating the correction value F_{B} is described below by referring to FIG. 2. In this case, FIG. 2 is a flowchart for explaining the method for calculating the correction value F_{B}.

First, in step 21, nitrogen is injected into a chamber A2 to sufficiently saturate the chamber A2 with nitrogen, that is, to sufficiently replace air and nitrogen in the chamber A2. In other words, moisture and oxygen are removed. The expression “saturation” denotes an oxygen density and moisture density respectively stabilized at a certain value after a long-enough time passes and gas replacement is performed. Then, in step 22, nitrogen is injected into the chamber B5 to operate the oxygen-moisture densitometer 6. Then, in step 23, a laser beam is emitted from the F₂ excimer laser beam source 1 by a predetermined number of pulses (e.g. three pulses). The number of pulses P_{M} necessary for exposure can be obtained by the following expression in accordance with a light exposure E_{M} necessary for exposure of a wafer and exposure energy E_{P} per pulse. In this case, however, a sampling frequency necessary to obtain the correction value FB is set.

P_{M}=E_{M}/E_{P} (Numerical formula 7)

Then, in step 24, values of the light exposure detector A4, light exposure detector B7 and oxygen-moisture densitometer 6 are measured and stored in a (not-illustrated memory) of the controller 8.

Then, in step 25, it is determined whether the value of the oxygen-moisture densitometer is saturated. The value is determined to be saturated because it is necessary to store the difference (correction value in this case) between an expected simulation and an actual value in a controller and thereby, it is necessary to store data while gas is sufficiently replaced as described above. In this case, when it is determined in step 25 that each value is not saturated, steps 23 and 24 are restarted to store values of light exposure, oxygen density and moisture density in the controller 8.

When each value is saturated, a laser beam is emitted in step 26 and stopped after step 24 is executed. Strictly, steps 23 and 26 respectively include a step of determining whether the number of pulses reaches a predetermined value and continuously emitting a laser beam until it is determined that the number of pulses reaches the predetermined value.

In step 27, the correction value F_{B} is calculated by Numerical formula 6. The calculated correction value F_{B} is stored in the controller 8 at any time. As described above, correction values are obtained in advance in accordance with various oxygen densities and moisture densities from a calculated oxygen density and moisture density.

Then, the excimer laser beam source 1 is corrected as described below at the time of exposure. First, the oxygen density and moisture density in the chamber B5 are measured by the oxygen-moisture densitometer 6. Then, based on the value, a quantity absorbed in oxygen and moisture in the chamber B5 is calculated by using Numerical formulas 1 to 4. At the same time, the correction value F_{B} at the oxygen density and moisture density is read out from the controller 8. Moreover, the light exposure E_{M} (=E_{B}) necessary at the time of exposure is set to the light exposure detector B7 on the controller 8 in accordance with Numerical formula 6 to calculate a value E_{A} (=E_{M}+C_{B}+O_{B}+W_{B}+F_{B}) to be detected by the light exposure detector A4 in accordance with Numerical formula 6. A beam is emitted from the excimer laser beam source 1 until the necessary value E_{A} is reached while monitoring the light exposure detector A4 in accordance with the obtained value. When emitting one pulse of the laser beam, a part of the beam is absorbed in oxygen. However, because the number of oxygen molecules is decreased due to ozonization, O_{B} is decreased for the next pulse and thereby, E_{A} is changed whenever emitting the laser beam. Then, even if obtaining E_{A} after emitting several pulses, it may not be a necessary value any longer. In this case, by detecting an oxygen density and moisture density again and reading out the data based on the oxygen density and moisture density from the controller, E_{A} is calculated to correct the emission quantity of the laser.

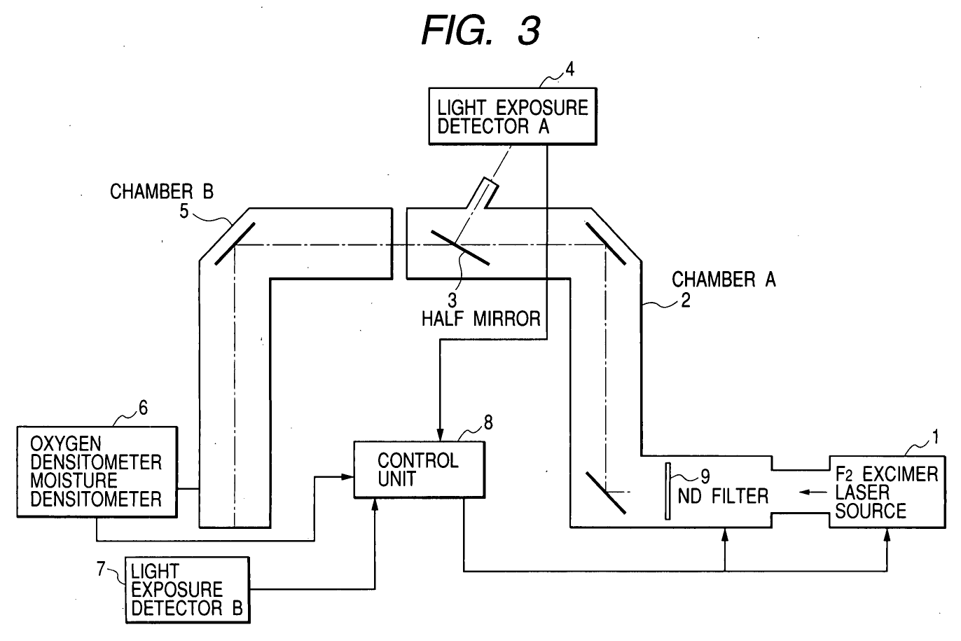

A light exposure more than a necessary light exposure may be obtained. This is described below by referring to FIGS. 3 and 4. FIG. 3 is a schematic block diagram showing that quantity-of-light change means is set to an aligner of the present invention. In FIG. 3, reference numeral 9 denotes an ND filter having a function for reducing the quantity of light of the F₂ excimer laser source 1. FIG. 4 is a flowchart for explaining the quantity-of-light control operation using the ND filter 9.

In step 41, the ND filter 9 is set so that the maximum quantity of light passes through the filter. In step 42, it is communicated to the F₂ excimer laser source to emit one pulse of a laser beam from the controller 8. In step 43, one pulse of an F₂ laser beam is emitted. In step 44, a light exposure is monitored by the light exposure detector A4 and as a result, E_{A} is transferred to the controller 8. In step 45, the light exposure obtained by a value EA1 detected from “(set necessary light exposure E_{M}−accumulated light exposure E_{AP} obtained by the light exposure detector A4)/value E_{A} detected by light exposure detector A4” is computed by the controller 8 to compute whether the obtained result is smaller than 1. In this case, when the result is not kept in the range, “already set light exposure E_{M}=already set light exposure E_{M}−accumulated light exposure E_{AP} obtained by the light exposure detector A4” is set again to repeat steps 42 to 45. In step 46, when the obtained result is smaller than 1, a light exposure more than a necessary light exposure is obtained by emitting one pulse of the final laser beam. Therefore, a quantity of light to be reduced by the ND filter 9 is computed by the controller 8 in accordance with the value obtained in step 45 to operate the ND filter 9. In step 47, only one pulse of the F₂ laser beam is emitted to complete the processing.

As described above, according to this embodiment, it is possible to perform a high-accuracy light exposure control during exposure even if the oxygen density and moisture density in the chamber B are any values. Moreover, even in the case in which a light exposure more than a necessary light exposure is obtained by emitting one pulse of the final laser beam, it is possible to obtain a proper light exposure by operating the quantity-of-light change means.

This embodiment uses an ND filter as a method for controlling a light exposure (quantity of light of exposure light reaching wafer). However, without being restricted to the above mentioned, it is also allowed to change opening diameters of an iris diaphragm or make the quantity of light emitted from a light source variable.

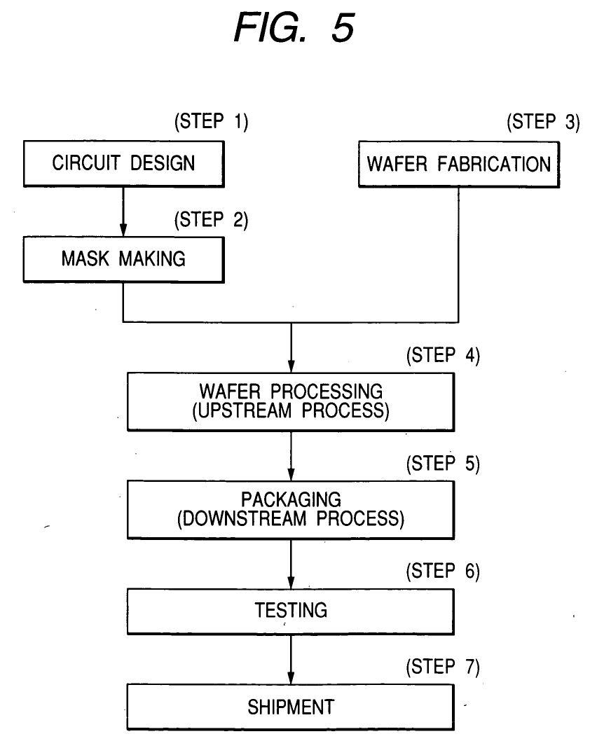

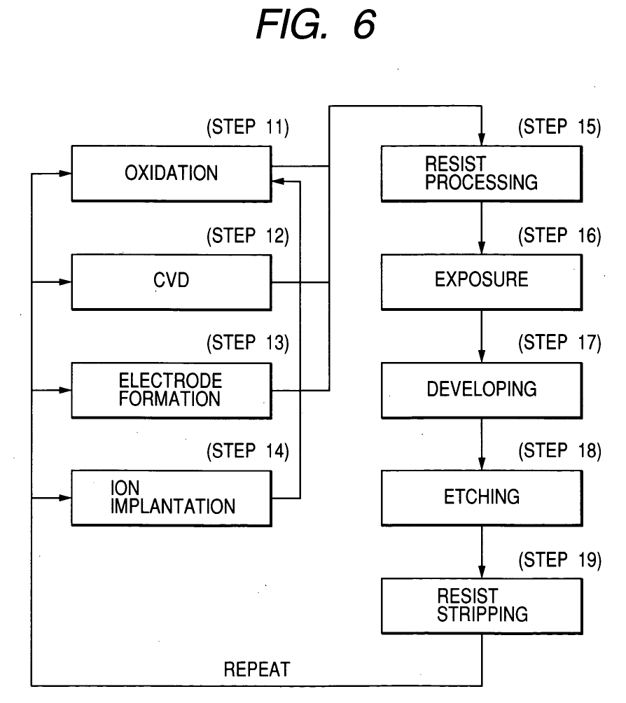

Then, an embodiment of a device fabrication method using the aligner shown in FIG. 1 or 3 is described below with reference to FIGS. 5 and 6. FIG. 5 is a flowchart for explaining fabrication of a device (semiconductor chip such as IC or LSI, or LCD or CCD). In this case, fabrication of a semiconductor chip is described as an example. In step 1 (circuit design), a circuit of a device is designed. In step 2 (mask making), a mask on which a designed circuit pattern is formed is made. In step 3 (wafer fabrication), a wafer is fabricated by using a material such as silicon. Step 4 (wafer process) is referred to as an upstream process in which an actual circuit is formed on a wafer through the lithography by using a mask and the wafer. Step 5 (packaging) is referred to as a downstream process which is a process for forming a semiconductor chip by using the wafer formed in step 4 and includes an assembly process (dicing and bonding) and a packaging process (chip sealing). In step 6 (testing), an operation confirmation test and a durability test of a semiconductor device fabricated in step 5 are performed. The semiconductor device is completed after passing through these processes and shipped (step 7).

FIG. 6 is a detailed flowchart of the wafer process in step 4. In step 11 (oxidation), the surface of the wafer is oxidized. In step 12 (CVD), an insulative film is formed on the surface of the wafer. In step 13 (electrode formation), an electrode is formed on the wafer through vapor deposition or the like. In step 14 (ion implantation), ions are implanted into the wafer. In step 15 (resist processing), a photosensitive material is applied to the wafer. In step 16 (exposure), the circuit pattern of the mask is exposed to the wafer by the aligner shown in FIG. 1 or 3. In step 17 (developing), the exposed wafer is developed. In step 18 (etching), portions other than the developed resist image are shaved off. In step 19 (resist stripping), resist which is unnecessary because etching is finished is removed. By repeating these steps, circuit patterns are multiply formed on the wafer. According to the above device fabrication method, it is possible to fabricate a device having a higher quality than ever. Thus, a device fabrication method using an aligner and a device which is a resultant product constitute one side of the present invention.

The above device fabrication method effectively influences a device which is an intermediate and final resultant product. Moreover, the device includes a semiconductor chip such as an LSI or VLSI, CCD, LCD, magnetic sensor and thin-film magnetic head.

According to this embodiment, it is possible to provide an aligner capable of controlling a proper light exposure in accordance with an oxygen density and moisture density in an optical path.

What is claimed is:

1. An aligner for illuminating a mask (or reticle) with light emitted from a light source and exposing an object to be exposed with light reflected from the mask, comprising:
oxygen density detection means for detecting an oxygen density on an optical path between the light source and the object to be exposed;
moisture density detection means for detecting a moisture density on the optical path; and
control means for controlling a light exposure to be irradiated to the object to be exposed based on the detection results of the oxygen density detection means and the moisture density detection means.

2. The aligner according to claim 1, wherein
quantity-of-light detection means is included which detects a quantity of light at a predetermined position on the optical path.

3. The aligner according to claim 1, wherein
light exposure detection means is included which detects a quantity of light irradiated to the object to be exposed.

4. The aligner according to claim 1, wherein
the control means controls the light exposure in accordance with a relation between an absorbed quantity of light emitted from the light source (absorptance of light having a wavelength emitted from the light source) and an oxygen density (relation between absorbed quantity of light irradiated to the object to be exposed and a certain oxygen density).

5. The aligner according to claim 4, wherein
a relation between an oxygen density and an absorptance of light emitted from the light source is previously included as data.

6. The aligner according to claim 1, wherein
the control means controls the light exposure in accordance with a relation between an absorbed quantity of light emitted from the light source (absorptance of light having a wavelength emitted from the light source) and a moisture density (relation between an absorbed quantity of light irradiated to the object to be exposed and a certain moisture density).

7. The aligner according to claim 6, wherein
a relation between a moisture density and an absorbed quantity of light emitted from the light source is previously included as data.

8. The aligner according to claim 1, wherein
the light emitted from the light source is an excimer laser beam.

9. The aligner according to claim 8, wherein
the excimer laser beam is an F₂ laser beam.

10. The aligner according to claim 1, wherein
the control means has an ND filter and the ND filter controls a light exposure to be irradiated to the object to be exposed.

11. The aligner according to claim 1, wherein
the control means has a diaphragm to control a light exposure to be irradiated to the object to be exposed by changing opening diameters of the diaphragm.

12. A device fabrication method comprising:
a step of exposing the object to be exposed by using the aligner of claim 1; and
a step of developing the exposed object.

13. An aligner for transferring a pattern formed on a mask or reticle to an object to be exposed comprising:
quantity-of-light detection means for detecting a quantity of exposure light;
oxygen density detection means for detecting an oxygen density in an exposure environment;
moisture density detection means for detecting a moisture density in the exposure environment; and
control means for controlling the quantity of the exposure light in accordance with data showing the relation between the oxygen density, the moisture density and the absorbed quantity of the exposure light and detection results by the oxygen density detection means and the moisture detection means previously obtained.

14. A device fabrication method comprising:
a step exposing the object to be exposed by using the aligner of claim 13; and
a step of developing the exposed object.
